(19) United States
(12) Patent Application Publication
(10) Pub. No.: US 2012/0012687 A1
(43) Pub. Date: Jan. 19, 2012

(54) PULVERIZER COAL CLASSIFIER

(76) Inventor: Scott Vierstra, Canal Winchester, OH (US)

(21) Appl. No.: 13/182,309

(22) Filed: Jul. 13, 2011

Related U.S. Application Data
(60) Provisional application No. 61/399,730, filed on Jul. 16, 2010.

(51) Int. Cl. B02C 23/10; B07B 7/083

(52) U.S. Cl. 241/79; 209/142; 209/143

(57) ABSTRACT

An axial classifier, for separating the coarse particles from a fluid flow having both coarse and fine particles, comprising a housing forming a first chamber for the fluid flow to enter the classifier, a vane assembly provided within the housing, wherein the vane assembly includes a plurality of blades aligned around a flow diverter, a cone member forming a second chamber for the fluid flow to pass therein, wherein the cone member includes an opening for the coarse particles separated from the fluid flow to pass therethrough, and an outlet for the particles remaining in the fluid flow after separation of the coarse particles to exit the classifier, wherein the plurality of blades of the vane assembly abut an outer surface of the flow diverter to direct the fluid flow from the first chamber into the second chamber in a manner that congregates the coarse particles for classification.

### CROSS-REFERENCE TO RELATED PATENT APPLICATIONS

This application claims the benefit under 35 U.S.C. §119(e) of U.S. Provisional Patent Application No. 61/399,730, filed Jul. 16, 2010, the entire disclosure of which is incorporated herein by reference.

### BACKGROUND

The present application relates generally to classifiers for use in the separation of particles of a substance according to size, density, or mass. More specifically, the present application relates to static axial classifiers configured to more accurately separate the solid particles of a substance, such as a fuel (e.g., coal) to make the combustion of the fuel more efficient and to reduce undesirable emissions, or for other substances used in other industries, such as the solid particles used to form cement.

It is generally well known to use particle classifiers, such as coal classifiers, in the power industry, such as in coal-fired power plants. Typically, the particle classifier is positioned between a fuel crushing device (e.g., pulverizer) and a fuel combustion device (e.g., boiler, furnace). The coal enters the pulverizer as large pieces and exits transformed into smaller pieces, which then are directed into the classifier. The classifier separates the coal based on particle size, density, or mass, such that the larger or heavier particles are routed to pass through the pulverizer again for a further reduction in size, and where the smaller particles are directed to exit the classifier and enter the combustion device.

Classifiers may be configured to be external or internal to the particle size reduction equipment (e.g., pulverizer or milling) system. External classifiers may utilize piping or conveyance systems to inlet pulverized particles (e.g., coal particles) from a remote located pulverizer, then classify (e.g., separate based on a category, such as mass or size) the particles, rejecting and transferring the coarse particles through a pipe back to the pulverizer, and accepting and passing the fine particles through piping or a conveyance system to a downstream process (e.g., burner, furnace, etc.). Internal classifiers typically are constructed together with the pulverizer inline with the furnace (e.g., burner, boiler), to comprise a single system that pulverizes the raw material (e.g., fuel) then classifies the particles (e.g., fuel particles), passing the fine particles to the downstream process (e.g., burner, furnace, etc.) and rejecting the coarse particles to be further ground within the pulverizer to reduce the particle size. The present application relates to an improved classifier (for either internal or external applications) that more efficiently classifies the coarse and fine particles.

Additionally, classifiers have typically been grouped into two types, static and dynamic. Static classifiers generally involve the use of fluid (e.g., gas) flow to generate centrifugal forces by cyclones or swirling flows to move coarse particles to the peripheral walls of the classifier where a combination of gravity and friction overcomes drag forces, which allows the heavier or larger particles to drop out of the flow and be rejected back to the pulverizer. Conventional dynamic classifiers generally involve the use of rotating classifier blades to generate the centrifugal forces necessary to improve particle classification and physical impact with particles to reject them back to the pulverizer. The present application relates to an improved static classifier that more efficiently classifies (e.g., separates) the coarse and fine particles, such as a solid fuel (e.g., coal). Static classifiers may include moving and/or adjustable components, but typically are not automatically actuated. For example, static classifiers may be adjusted during operation of the pulverizer.

FIGS. 1A-1E illustrate an example of a conventional static axial internal classifier 10 that is integrally formed with a pulverizing device 9 to form a pulverized fuel system 8. The internal classifier 10 may be provided above the pulverizing device 9 to allow the raw material (e.g., crushed coal) to enter the pulverizer system from the top (or side) and through the use of gravity for the fuel source to pass into the pulverizing device 9. The internal classifier 10 includes a housing 11, a raw material inlet pipe 12, an outlet 13, a cone member 14, a vane (or baffle) assembly 15, a flow diverter 16, and may have one or more deflecting members 17. The housing 11 may be substantially cylindrical in shape and may extend upwardly to couple to the outlet 13 and extend downwardly to the base of the pulverizing device 9, forming a sealed internal chamber 18 configured for fluid flow (e.g., air or gas and particle mixture). The housing 11 encloses the pulverizing device 9, as well as the cone member 14, the vane assembly 15 the flow diverter 16, and the deflecting member 17 of the classifier 10. The inlet pipe 12 is typically cylindrically shaped and concentric to the housing 11 passing through the center of the classifier 10 and into the pulverizing device 9. The inlet pipe 12 includes an upper portion 12a and a lower portion 12b, wherein solid material (e.g., crushed coal) enters the inlet pipe 12 through the upper portion 12a and exits the inlet pipe 12 through the lower portion 12b to then enter the pulverizing device 9 to reduce the particle size of the solid material. The inlet pipe 12 may also be located external to the classifier (e.g., the feed inlet pipe can extend through a side wall such as the wall of housing 11 shown in FIG. 1A rather than running through the center of the unit).

The outlet 13 may have a truncated cone shaped upper portion provided above a substantially cylindrical shaped lower portion that couples to the housing 11. The outlet 13 is concentric to and outside of the inlet pipe 12, such that fluid flows between the inside surface of the outlet 13 and the outside surface of the inlet pipe 12 when passing to the combustion device. The outlet 13 may convey the fluid and particle mixture to a downstream process. The vane assembly 15 is provided within the housing 11, below the outlet 13, and concentric to the inlet pipe 12. The vane assembly 15 may include a plurality of blades 15b that extend vertically at a tangential angle TA, as shown in FIG. 1D. The blades 15b extend short of (or are offset from) the flow diverter 16, such that there is a gap G1 between the ends of the blades 15b and the flow diverter 16. The flow diverter 16 is cylindrically shaped and is provided inside the vane assembly 15, and is positioned concentric to both the inlet pipe 12 and the vane assembly 15.

The cone member 14 is provided below the vane assembly 15 and inside the housing 11. The cone member 14 is hollow and tapers downwardly, narrowing toward the inlet pipe 12. The cone member 14 forms a second internal chamber 19 for fluid to flow within. The deflecting member 17 is provided inside the cone member 14 near the lower narrower portion of the cone member 14 and abuts the outside surface of the inlet pipe 12. The deflecting member 17 is an inverted cone, with the larger diameter at the bottom, tapering upwardly toward the inlet pipe 12. Provided below the cone member 14 and integrally formed with the cone member 14 is a reject device 20. The reject device 20 may include a plurality of chutes aligned in a radial direction around the inlet pipe 12 or may be an annular gap formed between the base of the cone member 14 and the inlet pipe 12. The reject device 20 is configured to deliver the rejected coarse particles from the second internal chamber 19 to the pulverizing device 9.

The intended flow of fluid within the classifier 10 is illustrated in FIG. 1E by the arrows (some of which are labeled “A,” “F,” and “C”). The aggregate flow of fluid (denoted as “A”) exits the pulverizing device 9 and enters the chamber 18 of the classifier 10 traveling upwardly passing between the inside surface of the housing 11 and the outside surface of the cone member 14. According to an exemplary embodiment, the aggregate flow of fluid may include a mixture of fluid (e.g., air) and solid particles (e.g., coal particles) having both coarse and fine particles. The aggregate flow of fluid passes between the blades of the vane assembly 15 and is forced downwardly by the flow diverter 16 into second internal chamber 19, where it is desired that the fluid flow and the fine particles (denoted “F”) ascend between the flow diverter 16 and the inlet pipe 12 passing into the outlet 13, and it is further desired that the coarse particles (denoted “C”) continue descending along the inside of the cone member 14. It is also desired that the deflecting member 17 assist in redirecting the fluid flow and the fine particles F upward, while trapping and permitting coarse particles C to pass between the cone member 14 and the deflecting member 17, and back to the pulverizing device 9.

Conventional static axial classifiers, such as the classifier shown in FIGS. 1A-1E, have several deficiencies, only some of which are described herein. A first deficiency of conventional static axial classifiers is that they may provide less than optimal separation of the coarsest particles (e.g., greater than 200 microns or micrometers) relative to total particles through the outlet pipe, which in the example of pulverized fuel may reduce the efficiency of the burner or furnace. The less than optimal separation of fine and coarse particles is caused by the relatively high velocities and swirl of the particles passing from the chamber 18 between the blades 15b of the vane assembly 15 and into chamber 19. The high swirl creates mixing and encourages the undesirable rejection of some mid-size and fine particles. The high velocities produce sufficient drag forces and turbulence to re-entrain coarse particles in the fluid flow.

The high velocities and swirl further create a second deficiency, a relatively high pressure drop from chamber 18 to chamber 13. This pressure drop compromises the efficiency of the pulverizer system by requiring a high output device (e.g., fan) to generate sufficient flow to carry the particles to the downstream process. The elevated pressure drop across the classifier also encourages potential fluid flow through the coarse particle reject device, thereby bypassing the classifier blades and flow diverter, which results in the counter flow of the desired coarse particle flow direction.

Proper particle size classification impacts the efficiency of the downstream process, thereby influencing the value of the product. For example, with solid fuel (e.g., coal) pulverization, the coarse particles are less likely to burn or oxidize to completion, which produces combustion inefficiencies, an increased potential for ash deposition in the combustion chamber, and increased difficulties in the collection of carbon-laden ash in the electrostatic precipitators.

For the suspension burning of solid fuels and the increased use of combustion staging (integral or separated from the primary flames), which are generally used for the control of emissions of nitrogen oxides, the top size of particles injected into the combustion zone is of great concern. Since the coal char or fixed carbon oxidizes on the surface exposed to the oxygen, the initial size of the particle and the particle's surface area to weight or volume ratio influences the overall reaction rate during combustion. Smaller or finer particles will oxidize more quickly than larger or coarser particles. Increasing the fraction of fine coal particles relative to total particles injected into the combustion zone generally improves the efficiency of the combustion-side nitrogen oxide emission control technologies and reduces the potential for unburned coal (or char) exiting the combustion zone.

### SUMMARY

One embodiment of the present invention relates to an axial classifier for separating coarse particles from a fluid flow having both coarse and fine particles. The axial classifier includes a housing forming a first chamber for the fluid flow to enter the classifier, and a vane assembly provided within the housing, wherein the vane assembly includes a plurality of blades aligned around a flow diverter. The axial classifier also includes a cone member forming a second chamber for the fluid flow to pass therein, wherein the cone member includes an opening for the coarse particles separated from the fluid flow to pass therethrough, and an outlet for the particles remaining in the fluid flow after separation of the coarse particles to exit the classifier. The plurality of blades of the vane assembly abut a surface of the flow diverter to direct the fluid flow from the first chamber into the second chamber in a manner that congregates the coarse particles for classification.

Another embodiment of the present invention relates to a pulverizer classifier system that includes an inlet pipe, a pulverizing assembly, and an axial classifier. The inlet pipe includes a first end and a second end, wherein the first end receives particles of a raw material and the second end outputs the particles of the raw material. The pulverizing assembly is configured to receive the particles of the raw material from the inlet pipe, wherein the pulverizing assembly is configured to reduce the size of the particles and to output the fluid flow comprising coarse and fine particles of the raw material. The axial classifier is configured to receive the fluid flow from the pulverizing assembly and separates the coarse particles of the raw material from the fluid flow based on the size (and/or weight) of the coarse particles. The axial classifier includes a housing forming a first chamber, a cone member forming a second chamber, a vane assembly and a flow diverter. The vane assembly includes a plurality of blades that are aligned around the flow diverter having a pitch angle to control the swirl and velocity of the particles of the fluid flow passing from the first chamber to the second chamber. The cone member includes an opening for the coarse particles separated from the fluid flow to pass through to reenter the pulverizing assembly.

### BRIEF DESCRIPTION OF THE DRAWINGS

FIG. 1A is a front-sectional view of an embodiment of a conventional pulverizer classifier system.

FIG. 1B is a front view of a conventional classifier for use in a conventional pulverizer classifier system, such as the system shown in FIG. 1A.

FIG. 1C is a perspective-sectional view of the conventional classifier.

FIG. 1D is a top-sectional view of the blades and flow diverter of the conventional classifier of FIG. 1B.

FIG. 1E is a front view illustrating the intended particle flow in the conventional classifier of FIG. 1B.

FIG. 2 is a perspective partial-cutaway view of a pulverizer classifier system, according to an exemplary embodiment.

FIG. 3 is a front-sectional view of a pulverizer classifier system, according to an exemplary embodiment.

FIG. 4 is a perspective partial-cutaway view of an exemplary embodiment of a classifier assembly for use in a pulverizer classifier system, such as the pulverizer classifier system shown in FIG. 3.

FIG. 4A is a perspective view of various components of the classifier assembly of FIG. 4.

FIG. 4B is a perspective-sectional view of the classifier assembly shown in FIG. 4.

FIG. 4C is a front-sectional view of the classifier assembly shown in FIG. 4.

FIG. 4D is a detail view of deflector and vane assembly of the classifier assembly shown in FIG. 4C.

FIG. 4E is a perspective view of the classifier assembly shown in FIG. 4A with the outlet and top portion of the housing removed for clarity.

FIG. 5 is a perspective view showing exemplary embodiments of the flow diverter and the vane assembly of the classifier assembly shown in FIG. 4.

FIG. 5B is a bottom view of the flow diverter and vane assembly shown in FIG. 5.

FIG. 5C is a front view of the flow diverter and vane assembly shown in FIG. 5.

FIG. 5D is an exemplary embodiment of a blade for use in a vane assembly, such as the vane assembly of FIG. 5.

FIG. 5E is a cross-sectional view taken along line 5E-5E of FIG. 5 showing the flow of the fine and coarse particles across the blades of the vane assembly.

FIG. 5F is a front view of a flow diverter and a vane assembly, according to another exemplary embodiment.

FIG. 6 is a front-sectional view of another exemplary embodiment of a classifier assembly for use in a pulverizer classifier system.

FIGS. 6A and 6B are detail views of different configurations of deflecting members within the classifier of FIG. 6.

FIG. 7 is a perspective view of yet another exemplary embodiment of a classifier assembly for use in a pulverizer classifier system.

FIG. 8 is a plot of measured and predicted particle size distributions at classifier output.

FIG. 9 is a CFD analysis of the simulated pressure distribution within a conventional classifier assembly.

FIG. 10 is a CFD analysis of the simulated pressure distribution within an exemplary embodiment of a classifier assembly.

FIG. 11 is a CFD analysis of the simulated velocity magnitude distribution within the conventional classifier assembly of FIG. 9.

FIG. 12 is a CFD analysis of the simulated velocity magnitude distribution within the classifier assembly of FIG. 10.

FIG. 13 is a chart illustrating the percent passing to the downstream process of the particle size ranges for the conventional classifier of FIG. 1B, the exemplary classifier of FIG. 4, and an actual working field test sample.

FIG. 14 is a chart illustrating the percent rejected back to the grinding zone of the pulverizing chamber based on the particle size ranges for the conventional classifier of FIG. 1B and the exemplary classifier of FIG. 4.

FIG. 15 illustrates a pulverizer classifier system configured to have an external classifier.

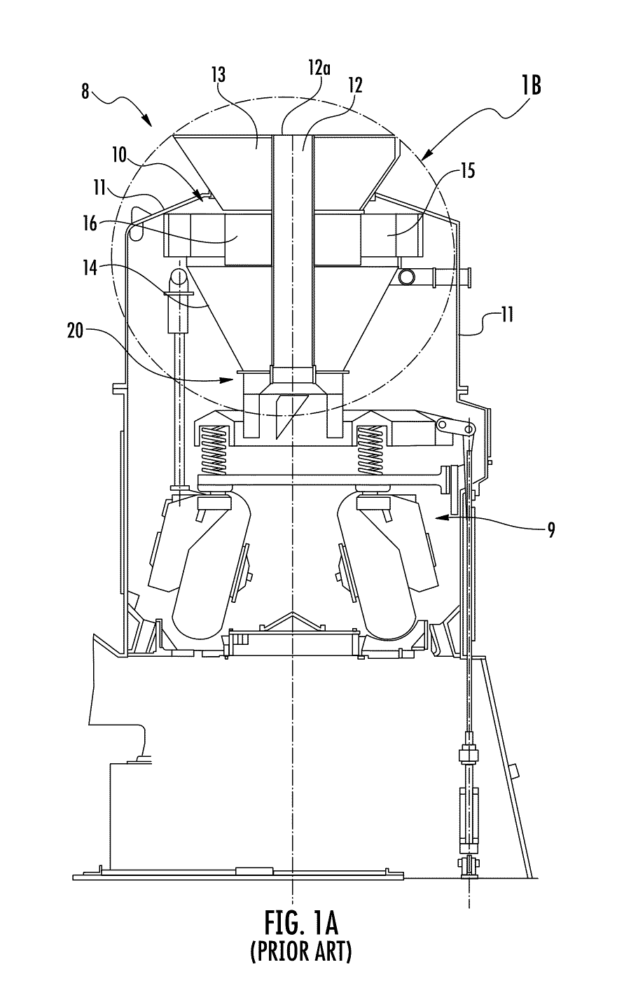

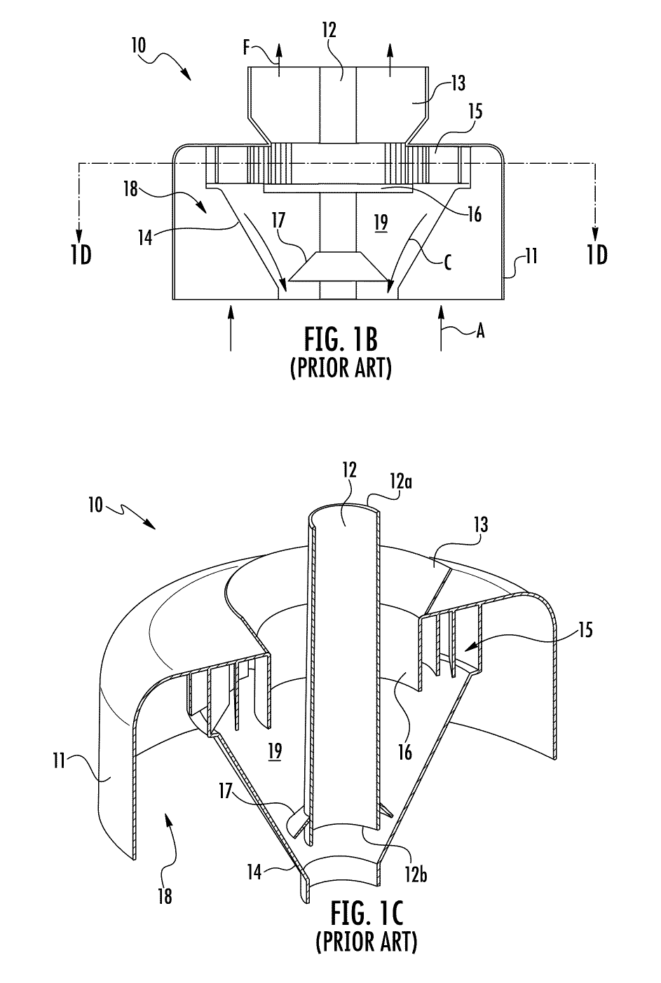

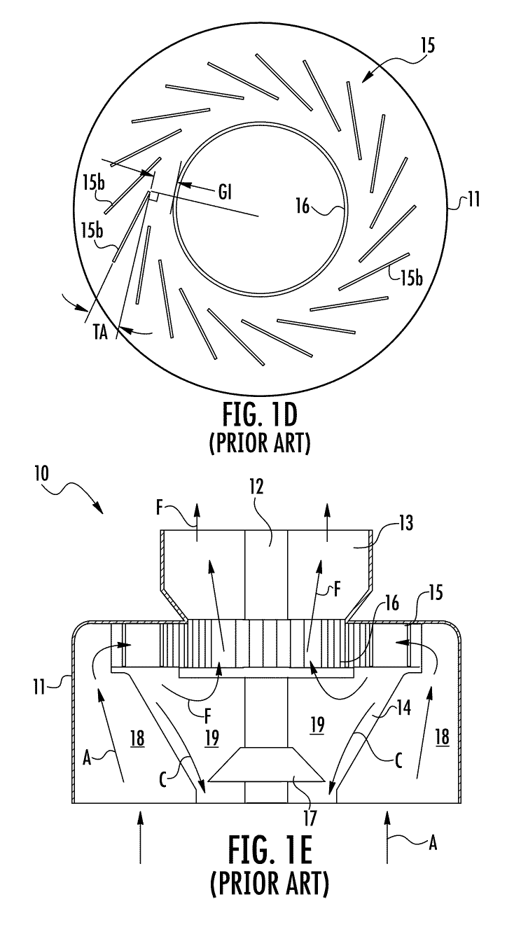

### DETAILED DESCRIPTION

The static axial classifiers described below improve coarse particle separation efficiency over conventional classifiers by reducing the number and mass fraction of coarse particles relative to the number and mass of total particles that exit the classifier which are then introduced to the downstream process or device (e.g., furnace). The classifiers, by increasing the fraction of fine particles relative to the total number of particles entering a combustion zone utilizing solid fuels burned in suspension, improve the efficiency of the combustion device, may reduce the amount of undesirable emissions, and reduce the fraction of fuel that may exit the combustion zone unburned. The static axial classifiers described below increase the fraction of fine particles to the downstream process or device by more efficiently separating the coarse particles from the fluid flow within the classifier. The static axial classifiers are preferably configured for use in coal fired power plants burning in suspension and are used to separate coal particles received from a pulverizing device to transfer fine particles to a combustion zone, and reject (e.g., return) coarser particles back to the pulverizing device to undergo further size reduction. However, it should be noted that these axial classifiers may be utilized for separating any material comprising a powder or a combination of particles for use in any industry.

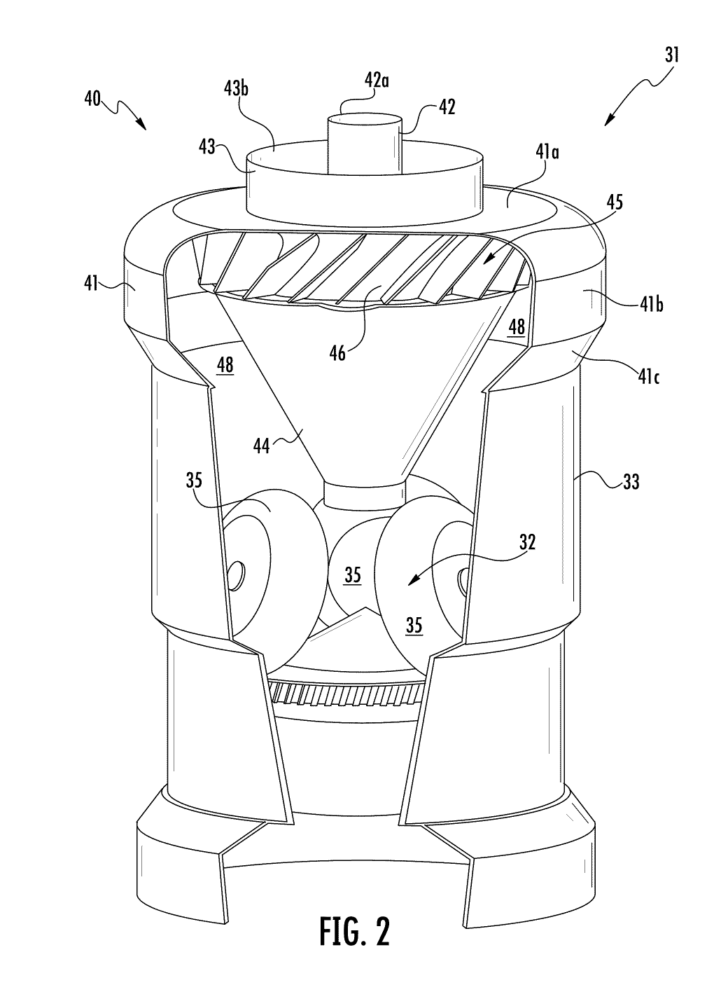

FIGS. 2-5E illustrate an exemplary embodiment of a pulverizer classifier system 31 (e.g., a pulverized fuel system) that includes a pulverizing assembly 32 and a classifier 40 (e.g., a classifier assembly) provided above the pulverizing assembly 32. Gravity may be utilized to feed the raw solid material (e.g., fuel) into the pulverizing assembly 32. The pulverizing assembly 32 may include a housing 33 that defines a pulverizing chamber 34, and at least one pulverizing device 35 for reducing the size of the particles (e.g., fuel) that enter the pulverizing chamber 34. According to the exemplary embodiment shown in FIG. 2, pulverizing assembly 32 may include three pulverizing devices 35 (although a greater or lesser number may be used according to other exemplary embodiments). The pulverizing chamber 34 is configured to receive raw solid materials (e.g., coal), as well as coarse particles separated and rejected by the classifier 40, whereby the pulverizing device 35 is configured to reduce the size of the particles (e.g., fuel). The pulverizer classifier system 31 may further include a flow inducing device (e.g., fan) to generate forces to produce flow of a fluid medium (e.g., air or gas) and the pulverized particles (e.g., fuel, coal) from the pulverizing chamber 34 of the pulverizing assembly 32 to the classifier 40. This flow may also be utilized to transport the pulverized particles to an associated downstream process or device (e.g., a burner). In the description below, the term “fluid” is intended to include both a fluid medium and particles (e.g., air or gas and coal), unless otherwise specified.

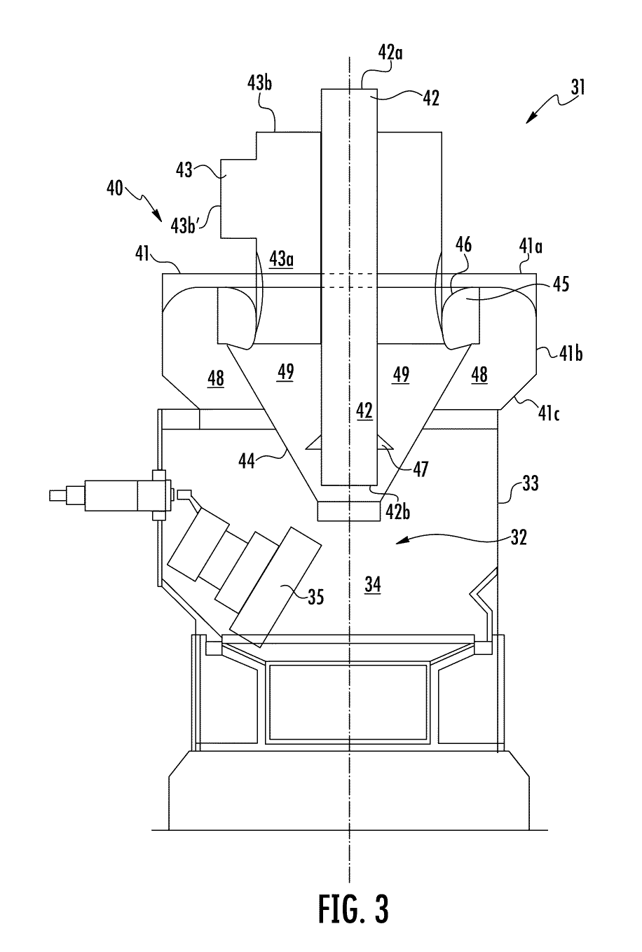

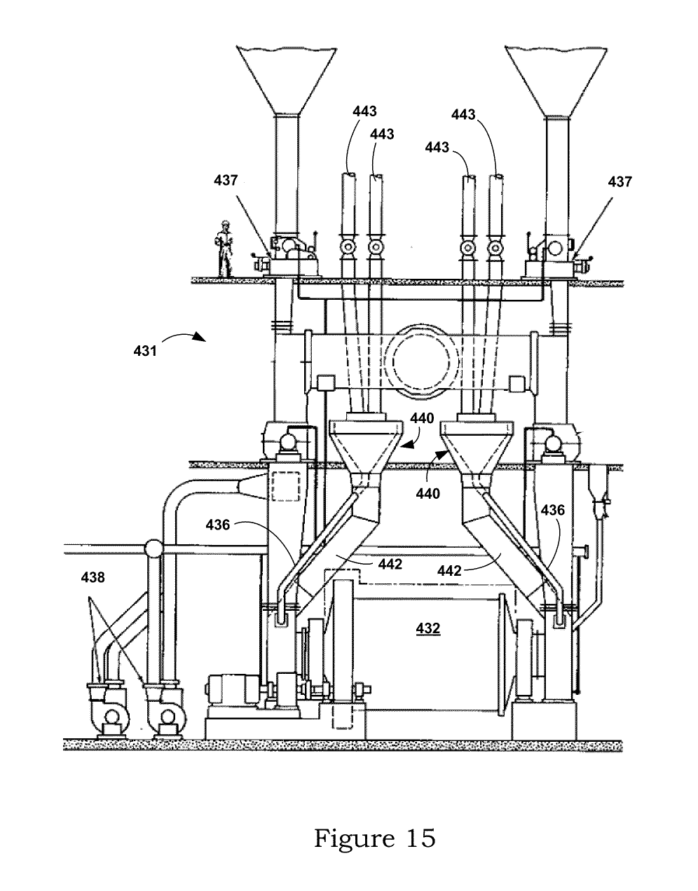

Although FIGS. 2 and 3 illustrate a pulverizer classifier system 31 that includes an internal classifier 40, it should be noted that the classifiers disclosed herein may be configured for use in other applications, such as in external applications. FIG. 15 illustrates a pulverizer classifier system 431 that includes a pair of external classifiers 440, wherein each classifier 440 receives a fluid flow having particles of a pulverized material (e.g., coal) through an inlet pipe 442 from a pulverizing assembly 432. The pulverizing assembly 432 may receive the raw material through a feeding device 437. The classifier 440 may separate the coarse particles from the bulk fluid flow, wherein the coarse particles may exit the classifier 440 back to the pulverizing assembly 432 through a first outlet pipe 436. The bulk fluid flow having the fine particles may exit the classifier 440 through one or more second outlet pipes 443, such as to pass to a downstream process (e.g., furnace). The pulverizer classifier system 431 may also include one or more fans 438, which may be configured to create a positive or negative vacuum to push or pull the fluid flow through the system 431 (or through a portion of the system 431). It should be noted that the pulverizer classifier system having external classifiers may have one external classifier or may have any number of external classifiers, and the embodiment disclosed herein is not meant as limiting.

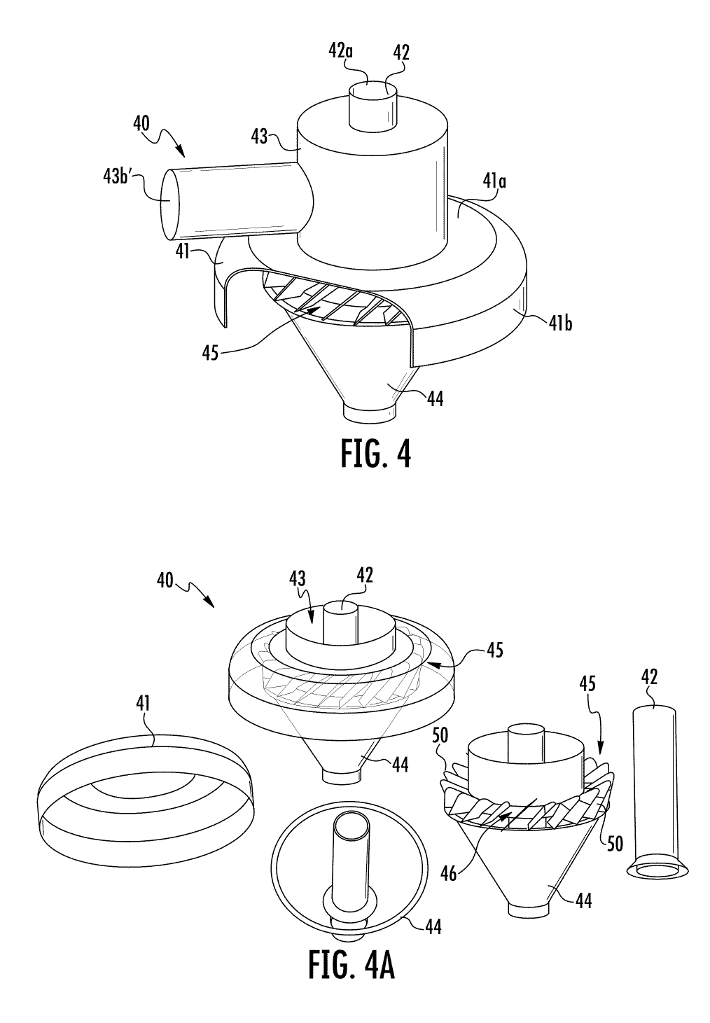

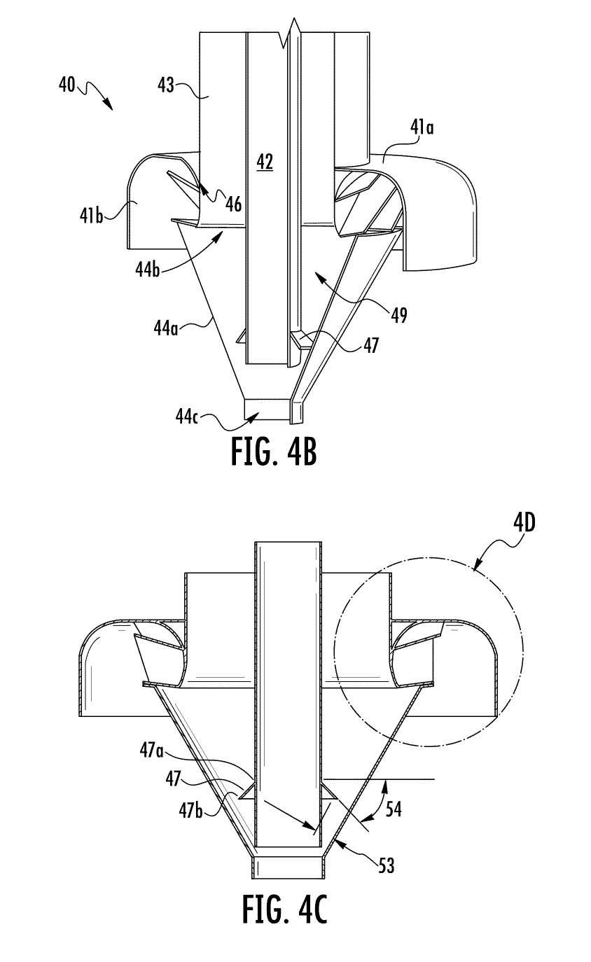

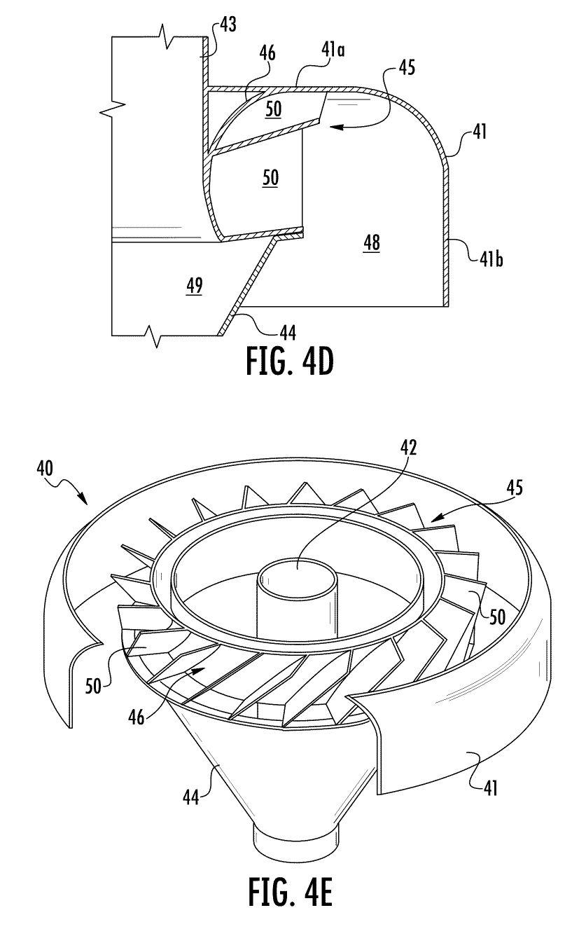

According to an exemplary embodiment, the classifier 40 includes a housing 41, an outlet 43, a cone member 44, a vane (or baffle) assembly 45, and a flow diverter 46. According to other exemplary embodiments, the classifier 40 may further include a deflecting member 47 and/or an inlet pipe 42, which may be centrally located to introduce raw solid material into the pulverizer classifier system 31. The housing 41 may be separately formed and then coupled to, or integrally formed with, housing 33 of the pulverizing assembly 32. According to the exemplary embodiment shown in FIG. 4A, the housing 41 may include a top portion 41a coupled to the outlet 43 and a cylindrically shaped portion 41b, which may extend upwardly to the top portion 41a and may extend downwardly to couple to the housing 33. According to an exemplary embodiment, the housing 41 may have an oblique portion 41c provided below cylindrical portion 41b that couples to housing 33. It should be noted that the housing geometry may vary, and the embodiments disclosed herein should be considered as illustrations and not as limitations.

The housing 41 encloses the vane assembly 45, the flow diverter 46, and at least a portion of both the cone member 44 and the inlet pipe 42. According to an exemplary embodiment, the housing 41 defines a sealed first chamber 48 provided between the inside surface of the housing 41 and the outside surface of the cone member 44, wherein the first chamber 48 is configured for fluid flow, such as a fluid comprising a mixture of air and particles (e.g., coal). The first chamber 48 formed by the housing 41 may be configured for a negative or a positive operating pressure.

According to an exemplary embodiment, the inlet pipe 42 has a generally cylindrical shape and may pass concentrically through the housing from the top. According to other embodiments, the inlet pipe may have any suitable shape and may pass through the side of the housing or may have any other suitable configuration. The inlet pipe 42 includes a first end 42a for receiving a raw solid material (e.g., fuel, coal) and a second end 42b (see FIG. 3) configured to allow the raw solid material to exit the inlet pipe 42 and enter the pulverizing chamber 34. This configuration efficiently utilizes gravity to deliver the raw solid particles (e.g., fuel, coal) passing through the inlet pipe 42 and into the pulverizing chamber 34. According to an exemplary embodiment, the second end 42b is provided within the cone member 44. According to other embodiments, the second end 42b of the inlet pipe may be provided within pulverizing chamber or anywhere within pulverizer classifier system.

According to an exemplary embodiment, the outlet 43 has a cylindrical shape and may be substantially concentric with the inlet pipe 42 and/or the housing 41, such that the fluid exiting the classifier 40 flows between the inside surface of the outlet 43 and the outside surface of the inlet pipe 42 before proceeding to the downstream process (e.g., a burner). According to other embodiments, the outlet may have any other suitable shape or configuration. The outlet 43 includes a first end 43a for receiving the fluid flow having fine particles, and a second end 43b where the fluid flow exits the classifier 40 to enter a conveyance member feeding a downstream process (e.g., a burner, a combustion zone). According to an exemplary embodiment, the first end 43a of the outlet 43 is coupled to the housing 41, such as to the top portion 41a of the housing 41. The outlet 43 may be formed separately then coupled to the housing 41, or may be integrally formed together. According to other embodiments, the first end 43a may couple to the flow diverter 46 or to other components of the pulverizer classifier system. As shown in FIGS. 3 and 4, the outlet 43 may also include a horizontally extending passageway 43b′ (or more than one passageway), wherein the passageway 43b′ may be connected to another device, such as, for example an exhauster fan.

According to an exemplary embodiment, the flow diverter 46 is provided within the housing 41 substantially concentric with the outlet 43 and forms an annular shape having a tailored cross-section (e.g., concave/convex) to divert the fluid to flow from the first chamber 48 into a second chamber 49. According to other embodiments, the flow diverter may have any suitable shape and configuration. As shown in FIG. 4E, the flow diverter 46 may be separately formed and coupled to the outlet 43 and/or the housing 41, or may be integrally formed with the outlet 43 and/or the housing 41. According to an exemplary embodiment, the flow diverter 46 includes a top surface that abuts and is coupled to the top portion 41a of the housing 41. According to another exemplary embodiment, the top surface of the flow diverter 46 may be integrally formed with housing 41, such as the top portion 41a. The flow diverter 46 may have a tailored convex/concave cross-section to direct the fluid flow, for example, in the direction of the inside surface of the cone member 44, which may help the separation of coarse particles from the fluid flow and direct the coarse particles toward the walls of the cone member 44, while maintaining sufficient drag forces to keep the fine particles in the fluid streamlines.

According to an exemplary embodiment, the vane (or baffle) assembly 45 is provided within the housing 41, abutting (i.e., touching in direct physical contact with, or integrally formed with) and substantially concentric with the flow diverter 46, such as shown in FIG. 4E. According to an exemplary embodiment, the vane assembly 45 may be integrally formed with flow diverter 46. According to another exemplary embodiment, the vane assembly 45 may be integrally formed with housing 41. According to other embodiments, the vane assembly may have any suitable configuration within the classifier.

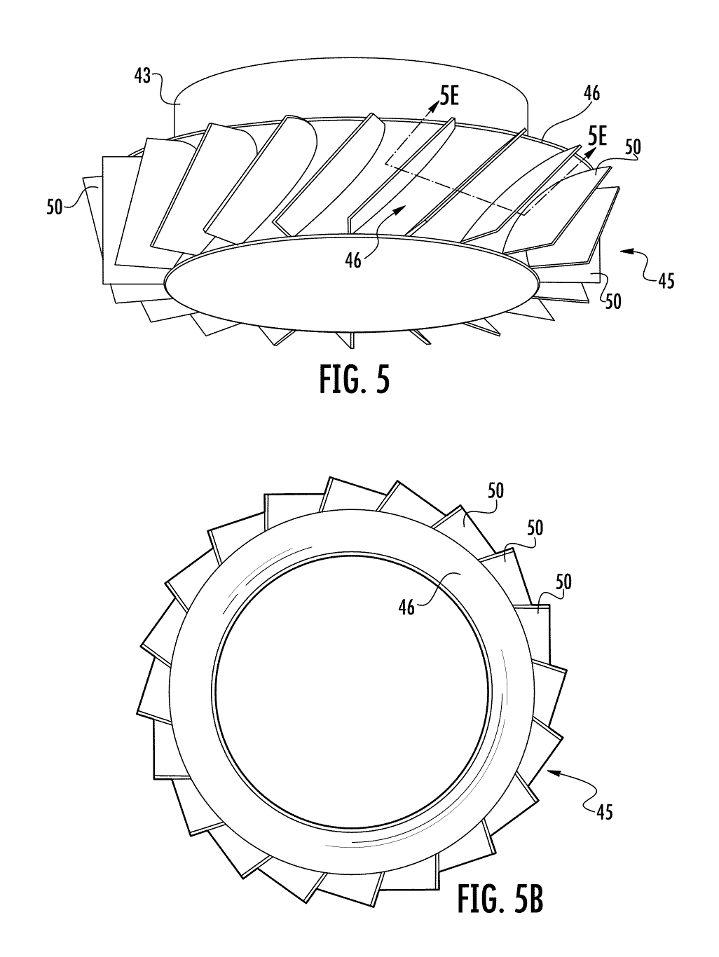

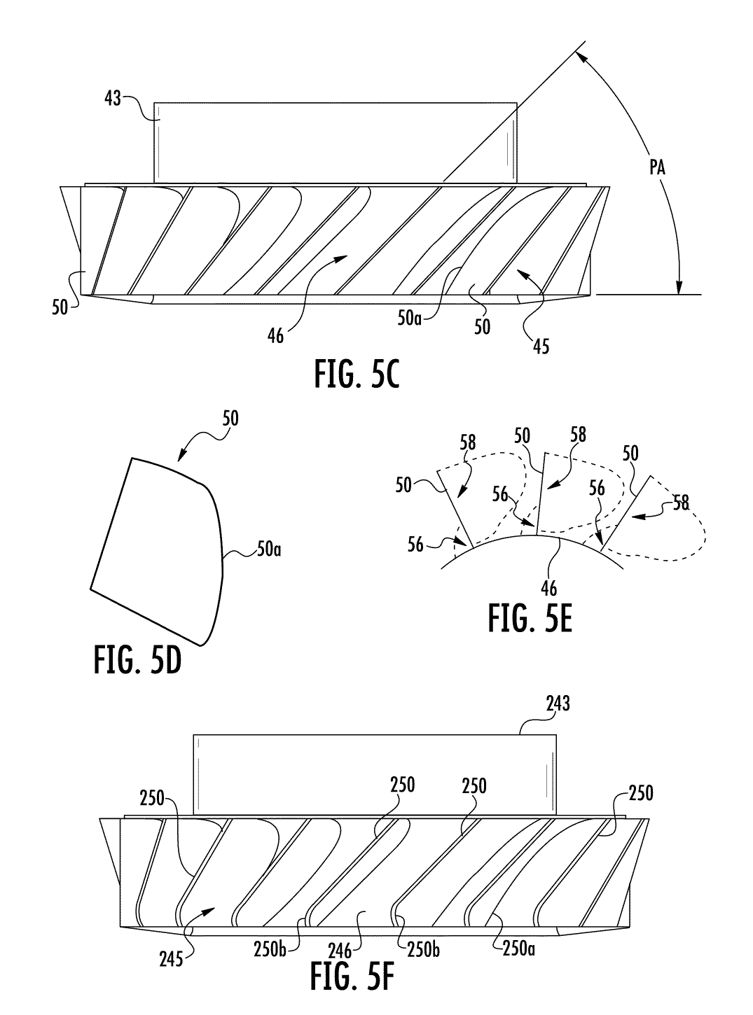

The vane assembly 45 includes a plurality of blades 50 that may have a radial alignment around the flow diverter 46 or may have any suitable alignment (e.g., skewed alignment) relative to the flow diverter 46. According to an exemplary embodiment, the vane assembly 45 may include 20 blades 50 aligned at substantially similar offsetting distances around the outer diameter of the flow diverter 46. According to other embodiments, the vane assembly 45 may include any number of blades, which may be aligned at similar or uniquely offsetting distances. The blades 50 of vane assembly 45 are angled at a pitch angle PA relative to horizontal and/or to the plane defined by the bottom or base of the flow diverter 46, as shown in FIG. 5C. According to an exemplary embodiment, the pitch angle PA may be forty degrees (40°). According to other embodiments, the pitch angle may be any angle that is greater than zero degrees (0°) and less than ninety degrees (90°). According to an exemplary embodiment, the pitch angle may be between approximately thirty-five (35) and forty-five (45) degrees. The blades 50 of the vane assembly 45 may extend downwardly to a location that is substantially coplanar with the bottom surface of the flow diverter 46, may extend downwardly to a location that is beyond (e.g., lower than) the bottom surface of the flow diverter 46, or may extend downwardly to a location that is short of (e.g., higher than) the bottom surface of the flow diverter 46, such as shown in FIG. 5C.

As shown in FIGS. 4-5C, the blades 50 of the vane assembly 45 of the classifier 40 may be configured in a radial alignment (e.g., clockwise alignment) to produce an axial clockwise flow direction of the fluid flow around the flow diverter 46. However, as shown in FIG. 7, the classifier 340 may include a vane assembly 345 that includes a plurality of blades 350 that are configured in a radial alignment (e.g., counter-clockwise) to produce an axial counter-clockwise flow direction of the fluid flow around a flow diverter 346.

According to the exemplary embodiment shown in FIG. 5D, the blade 50 includes a curved surface 50a, which may be configured to match the shape or profile (e.g., convex/concave curvature) of the flow diverter 46. The curved surface 50a of the blade abuts the outside convex/concave surface of the flow diverter 46, such that there is no gap between the blade and the flow diverter. The curved surface 50a may be coupled to flow diverter 46, such as by welding, or may be integrally formed therewith. Each blade 50 extends in length along a pitch angle PA from the upper (or top) edge (or surface) of the flow diverter 46 (and/or the top portion 41a of housing 41) to the top of the cone member 44. The pitch angle PA of each blade 50 may be measured relative to the lower edge of the flow diverter 46, which may be substantially horizontal, such as shown in FIG. 5C. The top of the cone member 44 may have a lip or extruded portion to abut the bottom surface or edge of the blades 50 of vane assembly 45. The lip or flange on the top of the cone member 44 may ease installation and provide an improved coupling between the vane assembly 45 and the cone member 44. The blade 50 extends laterally from the flow diverter 46 to substantially the outside diameter of the cone member 44. The blade 50 may extend laterally or diagonally to an outside distance less than or greater than the outside diameter of cone member 44.

As shown in FIG. 5F, the blades 250 of the vane assembly 245 may be configured to include a curved mounting surface 250a and a curved exit portion 250b. The vane assembly 245 may be provided below the outlet 243 of the classifier and may be configured to abut a flow diverter 246. For example, the curved mounting surface 250a of the blade 250 may abut a curved exterior surface of the flow diverter 246. The curved exit portion 250b of the blade 250 may curve from the pitch angle to influence the direction of the fluid flow passing through the blades. As shown in FIG. 5F, the curved exit portion 250b may curve from the pitch angle to a substantially downward direction to provide a more vertical discharge of the fluid flow passing through the blades 250 of the vane assembly 245. The curved portion may reduce the swirl of the fluid flow exiting the vane assembly, making it easier for the fine particles in the bulk fluid flow to turn upwardly toward the outlet of the classifier and further separate concentrations of coarse particles from the fluid flow. It should be noted that the shape of the curved portion 250b, as well as the shape of the blades 250, may be varied, such as to tailor the direction that the fluid flow exits the vane assembly, and the embodiments disclosed herein are not meant as limitations.

The classifiers disclosed herein include blades 50, 250, 350 that abut the flow diverters 46, 246, 346 (i.e., there is no gap) to better maintain the natural congregation of the coarse particles. By not having the gap between the blades 50 of the vane assembly 45 and the flow diverter 46 and by having a flow diverter geometry tailored to direct coarse particles toward the cone member 44, gravity and friction forces may overcome the drag forces from the fluid flow on the coarse particles. This induces the coarse particles to descend in the second chamber 49 of the cone member 44 to be rejected back to (e.g., reclaimed by) the pulverizing assembly 32 and/or the grinding zone for a further reduction in particle size. By additionally having the blades 50 aligned with a pitch angle PA instead of merely having a tangential angle, the swirl and velocity magnitudes of the particles entering and within the second chamber 49 are reduced and controlled. The reduced swirl and velocities also helps to reduce the amount of pressure drop from the first chamber 48 to the first end 43a of the outlet 43 relative to conventional classifiers. The reduced velocity magnitudes lower the drag forces to ameliorate the potential for re-entrainment of coarse particles back into the fluid flow. However, the reduced velocity magnitudes still have sufficient drag forces to retain the fine particles suspended in the fluid flow and to carry the fine particles to the outlet 43 of the classifier 40 to exit to a downstream process (e.g., a burner).

Pulverizer classifier systems having classifiers that operate having larger pressure drops are less efficient relative to the parasitic power requirements of the pulverizer classifier systems having classifiers that operate having smaller pressure drops. Classifiers having larger pressure drops, such as the conventional classifiers (where FIG. 9 shows the large pressure drop and is discussed in more detail below), require the fluid flow to enter the first chamber (e.g., chamber 18) of the classifier at a relative higher initial pressure in order to maintain enough pressure in the second chamber (e.g., chamber 19) to support flow requirements to deliver particles to the downstream process. Thus, classifiers having larger pressure drops require higher pressure capabilities on flow generating devices (e.g., fans) to generate the higher pressure gradient required to overcome the classifier pressure drop and functionally separate a portion of the coarse particles, albeit at a reduced classifier efficiency, such as in terms of energy required and particle classification.

The classifiers disclosed herein provide for improved pulverizer classifier system efficiency by having a smaller pressure drop (relative to conventional classifiers) in the classifier, in part due to the reduced velocities of the fluid passing between the blades of the vane assembly. The controlled swirl and velocity magnitudes regulate drag forces of the fluid flow thereby reducing the tendency to re-entrain the coarse particles in the fluid flow streamlines carrying the fine particles.

The redirection or transition of the fluid flow from the first chamber 48 through the vane assembly 45 and flow diverter 46 in the classifier 40 produces a segregation of coarse particles along the underside of the housing 41 and/or the curved flow diverter 46 of the classifier, in part, due to the relative momentums of the particles in the fluid flow. The drag forces of the fluid flow at this transition are sufficient to retain the fine particles in the bulk streamlines of the fluid flow. The trajectories of the coarse particles continue to follow the inner flow boundary along the contour of the flow diverter 46, where the coarse particles are further concentrated along the corner formed by the abutment between the top surface of the blades 50 and the flow diverter 46 (which is identified by reference numeral 56 in FIG. 5E). The fluid flow, having a relative lower density relative to the solid particles, remains more evenly distributed from top to bottom, entering the blades 50 of the classifier 40. In other words, the coarse particles tend to congregate at the upper portion of the opening into the vane assembly, whereas the fine particles in the fluid flow tend to more evenly distribute along the opening into the vane assembly. The combination of the contour of the flow diverter 46 and the configuration of the vane assembly 45 has the tendency to concentrate the bulk fluid flow and fine particles retained therein along the lower surface of the blades 50 of the classifier 40 (which is identified by reference numeral 58 in FIG. 5E). The separation of the coarse particles from the bulk fluid flow and the congregation of the coarse particles into a relative slower flow reduces the potential for the coarse particles to be re-entrained into the bulk fluid flow with the fine particles. The contour of the flow diverter 46 (e.g., the lower portion of the contour) directs the concentrated stream of coarse particles toward the inner surface of the cone member 44 and away from the bulk fluid flow, which further improves the efficiency of the classification (e.g., separation of the coarse particles back to the grinding zone of the pulverizing chamber 34) of the classifier 40.

The classifiers disclosed herein, therefore, allow for the pulverizer classifier system to be configured with a smaller output pressure generating device (relative to conventional classifiers), which improves efficiency by reducing energy consumption. The classifiers disclosed herein further increase efficiency of the system by having improved coarse particle separation in the classifier (relative to conventional classifiers) that reduce or eliminate the fraction of coarse particles relative to total particles that exit the classifier.

The classifiers disclosed herein, by producing a product having a finer particle size, increases the total particle surface area to mass or volume ratio. For combustion systems that utilize pulverized solid fuel (e.g., coal) that burns in suspension, the product having a finer particle size has the potential to further reduce emissions, such as emissions of nitrogen oxides, and to improve combustion efficiency. The coarse particles require a relative longer time to oxidize (relative to fine particles), which causes the coarse particles to oxidize farther away from the emissions control systems at the point of introduction to the combustion zone. The product having a finer particle size also reduces the tendency of the ash depositing in the combustion zone enclosure.

It should be noted that finer particles are also beneficial for use outside. As an example, for cement production, a finer particle size increases hydration rates and improves properties, such as higher early strengths.

According to an exemplary embodiment, the cone member 44 is provided within the housing, below and substantially concentric to the flow diverter 46. According to other embodiments, the cone member may have any suitable configuration within the classifier. The cone member 44 may be hollow, forming the second chamber 49, and may include an oblique wall 44a that forms the cone shape tapering toward the bottom (and the pulverizing assembly), as shown in FIG. 4B. The cone member 44 may include a first opening 44b formed by the annulus between the top edge of the wall 44a and the bottom surface of the flow diverter 46. The cone member 44 may also include a second opening 44c formed by the bottom edge of the wall 44a. The first opening 44b is configured to permit the fluid flow to enter the second chamber 49, for example, by passing between the blades 50 of vane assembly 45 from the first chamber 48. The second opening 44c is configured to permit coarse particles flowing through the second chamber 49 to exit the cone member 44 and enter the pulverizing assembly 32 for a further reduction in the size of the particles.

According to an exemplary embodiment, the deflecting member 47 is provided inside the cone member 44 abutting the outside surface of the inlet pipe 42. The deflecting member 47 may have an inner diameter 47a that abuts the inlet pipe 42, an outer diameter 47b that is larger than the inner diameter, and a wall that extends from the inner diameter to the outer diameter at an angle of taper 54, as shown in FIG. 4C. The inner diameter 47a of the deflecting member 47 may be varied to accommodate the outer diameter of the inlet pipe, while the outer diameter 47b of the deflecting member 47 may be varied to accommodate the desired gap 53 between the outer diameter of the deflecting member and the inside surface of the cone member 44, as shown in FIG. 4C. The angle of taper 54 may also be varied to tailor the material flow performance and to tailor the gap 53. The gap 53 may also be varied by positioning the deflecting member 47 at different heights along the inlet pipe 42 relative to the cone member 44. This gap 53 and/or the angle of taper 54 may influence the performance of the classification of the classifier 40, such as by influencing the tendency of the deflecting member 47 to redirect the fluid flow and the fine particles that descend in the second chamber 49 upwardly toward the outlet 43. The angle of taper 54 may form any angle between zero degrees (0°) and ninety degrees (90°), and preferably the angle of taper 54 may be greater than forty degrees (40°) relative to horizontal.

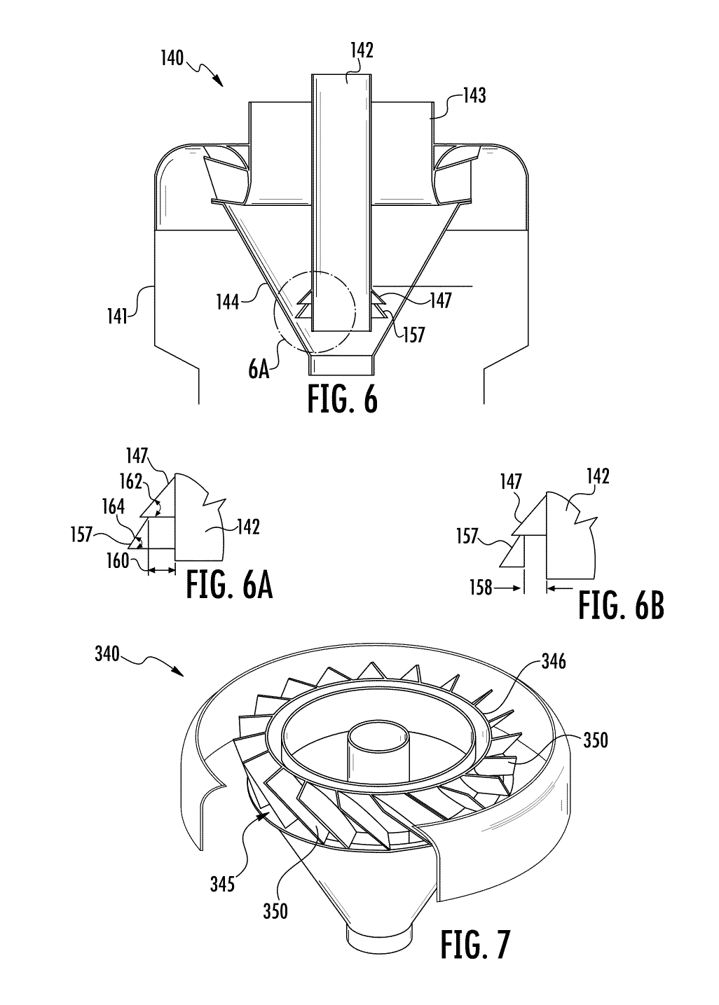

The classifier may also be configured to include more than one deflecting member, such as, by having multiple levels (e.g., layers) of deflecting members. According to the exemplary embodiment shown in FIG. 6, the classifier 140 may include a housing 141, an inlet pipe 142, an outlet 143, a cone member 144, a first deflecting member 147, and a second deflecting member 157. Other embodiments of classifiers may include a plurality of deflecting members. The first and second deflecting members 147, 157 may have substantially similar shapes or may have unique shapes, such as having different outer diameters or angles of taper. The second deflecting member 157 may be provided above or below the first deflecting member 147, such that the two members are separated by an offset distance or have some distance of overlap. According to the exemplary embodiment shown in FIG. 6B, a gap 158 may be provided between the second deflecting member 157 and the inlet pipe 142, where the gap 158 may help entrapped coarse particles descend to the pulverizing chamber. For example, the gap 158 may be about four inches between the inner diameter of the second deflecting member 157 and the inlet pipe 142. According to the exemplary embodiment shown in FIG. 6A, the second deflecting member 157 may abut the inlet pipe 142.

The second deflecting member 157 may extend away from the first deflecting member 147 at a distance 160 from the inlet pipe 142. As an example, the distance 160 may be four inches, although the distance 160 may be any length. The first deflecting member 147 may extend from the inlet pipe 142 in a tapered manner thereby defining an angle of incline 162. As an example, the angle of incline 162 of the first deflecting member 147 may be between forty and fifty degrees, although the angle of incline 162 may be configured at any oblique angle. The second deflecting member 157 may extend from the first deflecting member 147 (and/or the inlet pipe 142) in a tapered manner thereby defining a second angle of incline 164. The second angle of incline 164 of the second deflecting member 157 may be similar or different than the angle of incline 162 of the first deflecting member 147, and may be any oblique angle.

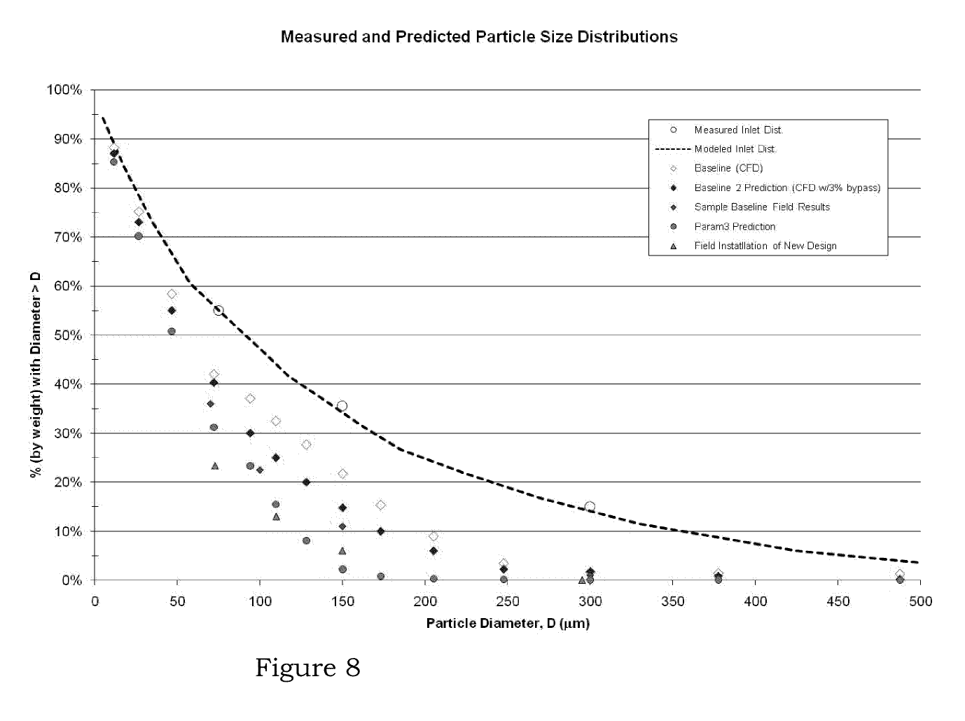

FIG. 8 illustrates a plot showing the measured and predicted particle size distributions at the classifier output for various classifier configurations. Plotted along the x-axis is the particle diameter (D) in microns. Plotted along the y-axis is the percent (%) by weight of particles having a diameter greater than D (the particle diameter corresponding on the x-axis). Therefore, it is desired to have a lower percentage on the y-axis for larger or coarse particle sizes, since a lower percentage on the y-axis corresponds to a higher level of fineness. The plot illustrating the predicted or simulated values using Computational Fluid Dynamics (CFD) computer analysis for the conventional classifier (labeled “Baseline”) configuration illustrates that the conventional classifier may allow coarse particles having a diameter as high as five-hundred (500) microns to exit the classifier outlet to pass into the combustion zone and may allow as much as ten percent (10%) of the particles having a diameter greater than two-hundred (200) microns (which is the generally preferred threshold diameter for coarse particles) to exit the classifier outlet and to pass into the combustion zone.

For comparison, the plot illustrating the predicted values using CFD analysis, for an exemplary embodiment of this application (labeled “Param3 Prediction”), illustrates that the y-axis reaches zero percent (0%) between 200 microns and 250 microns. This means the classifiers disclosed herein are predicted not to pass any coarse particles having a diameter greater than 250 microns and may only pass between zero percent (0%) and one percent (1%) of coarse particles having a diameter greater than 200 microns. The CFD analysis therefore predicts the separation efficiency of the classifiers disclosed herein to be increased somewhere between one percent (1%) and ten percent (10%), which in turn leads to an overall increase in efficiency of the pulverizer classifier system.

To one skilled in the art, this increase in efficiency is significant. For example, a classifier efficiency improvement, as disclosed herein, might improve the unburned carbon in flash emissions on the order of three percent (3%). If a 600 MW unit typically burns about 250 tons of coal per hour of a ten percent (10%) ash coal with eighty percent (80%) of the ash leaving the furnace as fly ash and being collected in an electrostatic precipitator, and typically operates at a capacity factor of 0.80, then the total cost to fuel the 600 MW unit described above with coal is $140.16 million per year, if the cost of coal is about $80 per ton. Thus, the unit described above would yield an estimated annual savings of $336,384 in fuel cost to produce an equivalent amount of power from the 600 MW unit (8760 hrs/yr×0.80 capacity factor×250 tons/hr×0.03 lb carbon/lb fly ash×0.1 lb ash/lb coal'0.8 lb fly ash/lb ash×$80/ton of coal). Of course, according to various exemplary embodiments, the amount of power output by a plant may vary, and the savings obtainable using the classifiers described herein will vary accordingly.

FIGS. 9-12 illustrate predictive analysis performed through Computation Fluid Dynamics (CFD) modeling that compares a conventional axial classifier to an exemplary embodiment of a classifier described herein at a pulverizer loading condition that is typical of normal full load operation. These Figures do not illustrate actual testing of classifiers, since CFD analysis is a computer modeling process used for predictive analysis. The typical output generated by CFD analysis are color contour plots having varying color gradients wherein specific colors are assigned to specific values (or magnitudes) of a parameter (e.g., pressure, velocity) using a given unit of measure (e.g., inches of water, meters per second). The hatching used in FIGS. 9-12 is intended to represent these gradients of the parameter evaluated in the CFD analysis by having solid lines demark sections of hatching labeled with a reference numeral that corresponds to a given range of values or magnitudes of that parameter using a given unit of measure. Thus, the hatching used in FIGS. 9-12 is not meant to denote stippling or a material of a structure of the classifier because the hatching used is meant to illustrate portions (or sections) of the classifier where the particles of fluid (e.g., fuel and air) pass through, wherein each portion represents ranges of values discussed below.

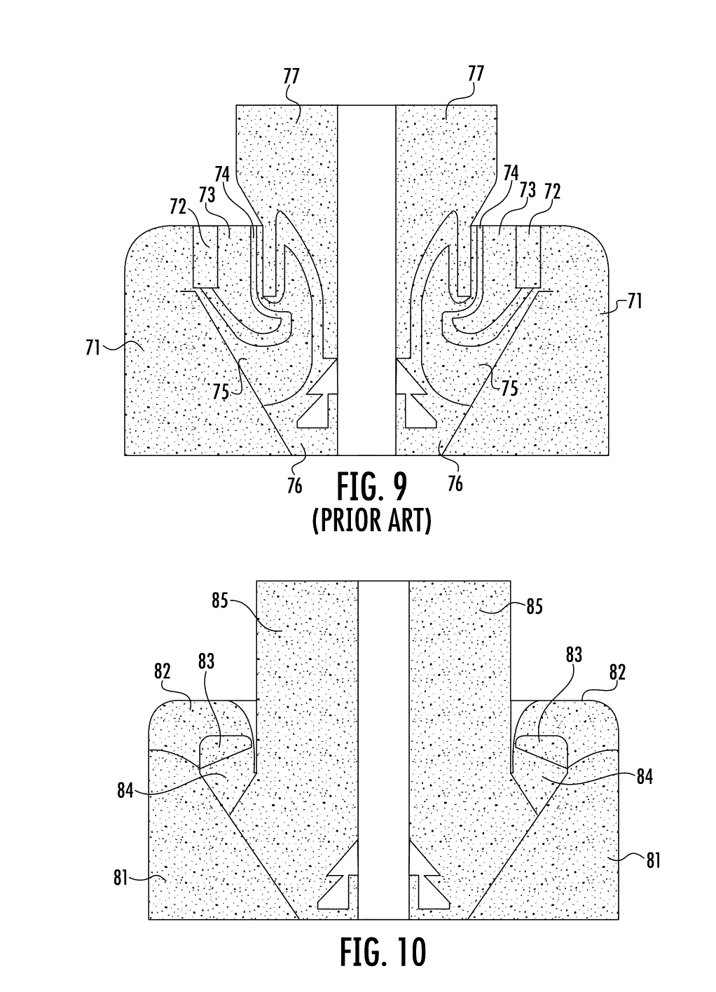

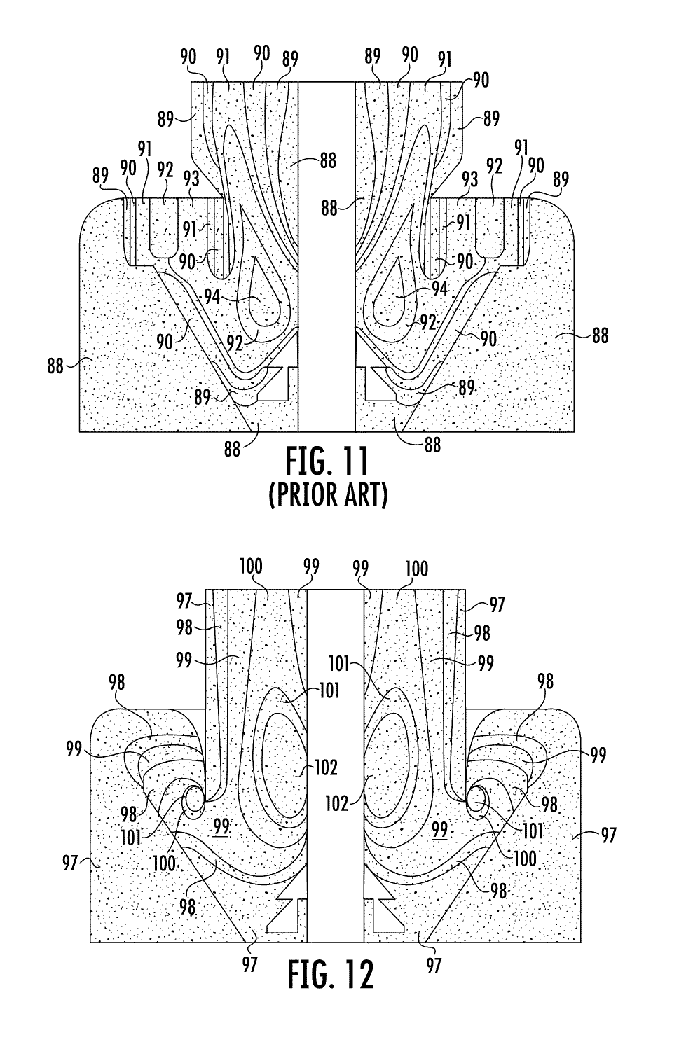

FIG. 9 illustrates the CFD predicted static pressure gradients within the conventional classifier, wherein the pressure gradients are measured in units of in H₂O (inches of water). FIG. 10 illustrates the CFD predicted static pressure gradients within an exemplary classifier, wherein the pressure gradients are measured in units of in H₂O (inches of water). It should be noted that the static pressures provided by the CFD computer analysis are not absolute pressures, but are relative pressures that can be used to evaluate the differential static pressures between the zones of the pulverizer and the classifier.

As shown in FIG. 9, the magnitude range labeled as gradient 71 corresponds to a predicted average static pressure of about 9.5 inches of water (in. H₂O), the magnitude range labeled as gradient 72 corresponds to a predicted average static pressure of about 6.5 inches of water (in. H₂O), the magnitude range labeled as gradient 73 corresponds to a predicted average static pressure of about 5.7 inches of water (in. H₂O), the magnitude range labeled as gradient 74 corresponds to a predicted average static pressure of about 4.8 inches of water (in. H₂O), the magnitude range labeled as gradient 75 corresponds to a predicted average static pressure of about 3.8 inches of water (in. H₂O), the magnitude range labeled as gradient 76 corresponds to a predicted average static pressure of about 2.8 inches of water (in. H₂O), and the magnitude range labeled as gradient 77 corresponds to a predicted average static pressure of about 0.8 inches of water (in. H₂O). The CFD predicts a substantial drop in the static pressure of the fluid flow passing from the first chamber through the vane assembly and into second chamber the conventional classifier. The CFD further predicts an additional drop in the static pressure of the fluid flow through the second chamber to the outlet of the classifier.

As shown in FIG. 10 for comparison, the magnitude range labeled as gradient 81 corresponds to a predicted average static pressure of about 2.8 inches of water (in. H₂O), the magnitude range labeled as gradient 82 corresponds to a predicted average static pressure of about 2.4 inches of water (in. H₂O), the magnitude range labeled as gradient 83 corresponds to a predicted average static pressure of about 1.9 inches of water (in. H₂O), the magnitude range labeled as gradient 84 corresponds to a predicted average static pressure of about 0.8 inches of water (in. H₂O), and the magnitude range labeled as gradient 85 corresponds to a predicted average static pressure range of between 0-0.8 inches of water (in. H₂O). The CFD predicts a slight drop in the static pressure of the fluid flow passing from the first chamber through the vane assembly and into the second chamber of the exemplary classifier (as disclosed herein). The CFD further predicts a very slight drop in the static pressure of the fluid flow through the second chamber to the outlet of the classifier.

Large pressure drops within the classifier increase the operational cost of the pulverizer classifier system, such as by requiring an increase in the draft and/or fan power requirements. The base of the cone member, of the classifiers described herein, is configured to reject entrapped particles to the pulverizing device or pulverizing chamber for further size reduction. Fluid flow through the reject section, such as from fluid bypassing the classifier vane assembly, is undesirable, because it may disturb the classification process and may re-entrain the coarse particles in the fluid flow exiting the classifier, which reduces the fineness of the product exiting the pulverizer classifier system. To minimize flow through the reject section, different options may be utilized. These include, but are not limited to, hinged doors that are actuated by weight of the rejected material, or controlled gaps that may be sealed by the volume of rejected particles plus the raw material entering the pulverizing device. Fluid flow through the reject section of the classifier may be regulated by the gaps or channels that might open along with the pressure gradient across these gaps or channels. Differences in operating pressure gradients produce bypass flows that are proportional to the square root of the ratio of the pressure gradients. The classifiers, as disclosed herein, are configured to reduce the pressure gradient across the reject section relative to conventional classifiers (e.g., by approximately one-third as compared to conventional classifier designs). The corresponding bypass flow potential is also reduced, such as by greater than forty percent (40%).

FIG. 11 illustrates the CFD predicted velocity gradients of the fluid flow within the conventional classifier, wherein the velocity gradients are measured in units of meters per second (m/s). FIG. 12 illustrates the CFD predicted velocity gradients of the fluid flow within an exemplary classifier, wherein the velocity gradients are measured in units of meters per second (m/s). Erosion is generally proportional to (or a function of) the flow velocity raised to the third or fourth power (e.g., erosion=f(velocity^{3.5})). Accordingly, any reduction in velocities through the classifier significantly reduces the wear and erosion of the classifier (e.g., internals). The reduced wear extends the life of the classifier and/or may allow the classifier to be constructed without costly linings (e.g., ceramic) or cladding that are aimed at ameliorating the wear in the classifier.

As shown in FIG. 11, the magnitude ranges labeled as gradient 88 corresponds to a predicted average velocity of about 4.0 meters per second (m/s), the magnitude ranges labeled as gradient 89 corresponds to a predicted average velocity of about 12.0 meters per second (m/s), the magnitude ranges labeled as gradient 90 corresponds to a predicted average velocity of about 16.0 meters per second (m/s), the magnitude ranges labeled as gradient 91 corresponds to a predicted average velocity of about 20.0 meters per second (m/s), the magnitude ranges labeled as gradient 92 corresponds to a predicted average velocity of about 32.0 meters per second (m/s), the magnitude range labeled as gradient 93 corresponds to a predicted average velocity of about 28.0 meters per second (m/s), and the magnitude range labeled as gradient 94 corresponds to a predicted average velocity of about 40.0 meters per second (m/s). The CFD modeling predicts high velocity magnitudes in the conventional classifier, as well as substantial variations in velocity magnitudes of the fluid flow.

The higher velocity magnitudes typically correspond to a higher amount of swirl, which contributes to the increased pressure drop discussed above. The high swirl and velocity magnitudes induce higher drag forces in the fluid flow, which have a tendency to entrain coarse and fine particles together in the flow, reducing the efficiency of separation. The higher drag forces require a higher reaction force (e.g., gravity, friction, etc.) to allow a particle to separate from the flow. Therefore, the higher drag forces tend to increase the number of coarse particles pulled along with the fine particles in the fluid flow exiting the classifier, resulting in a less efficient classifier. Thus, high velocity magnitudes and swirl result in an increased fraction of coarse particles relative to total particles provided by the pulverizer assembly passing to the downstream process (e.g., a combustion zone).

As shown in FIG. 12 for comparison, the magnitude ranges labeled as gradient 97 corresponds to a predicted average velocity of about 4.0 meters per second (m/s), the magnitude ranges labeled as gradient 98 corresponds to a predicted average velocity of about 12.0 meters per second (m/s), the magnitude ranges labeled as gradient 99 corresponds to a predicted average velocity of about 16.0 meters per second (m/s), the magnitude ranges labeled as gradient 100 corresponds to a predicted average velocity of about 20.0 meters per second (m/s), the magnitude ranges labeled as gradient 101 corresponds to a predicted average velocity of about 24.0 meters per second (m/s), and the magnitude range labeled as gradient 102 corresponds to a predicted average velocity of less than 28.0 meters per second (m/s). Thus, the CFD modeling predicts relatively significant lower velocity magnitudes for the exemplary classifier (or new classifier) relative to the conventional classifier of FIG. 11.

The trajectories of the particles through the classifiers influences the effective classification of the particles in the fluid flow. For both the conventional and the exemplary (or new) classifiers, the fluid flow (and the particles contained therein) enter the classifier flowing in an upwardly direction that is substantially vertical, then the fluid flow turns almost ninety degrees to flow in a substantially horizontal direction into the blades of the vane assembly.

The difference in inertias between the varying sizes of the particles in the fluid flow induces segregation between the coarse and the fine particles, as the fluid flow passes through the blades of the vane assembly. The fine particles remain for the most part evenly distributed from top to bottom upon entering the opening to the vane assembly, while the coarse particles become concentrated along the top portion of the opening to the vane assembly. For example, the particles that are about 18 microns in size generally will be distributed along the top eighty percent of the height (taken along a vertical cross-section) of the fluid flow entering the vane assembly, while particles that are 102 microns in size generally will be distributed along the top sixty percent of the height of the fluid flow. The particles that are 185 microns in size generally will be distributed along the top forty percent of the height of the fluid flow, and the particles that are greater than 270 microns in size generally will be distributed along the top twenty percent of the height of the fluid flow.

Within the conventional classifier, the fluid flow accelerated through the blades, creating a relative high swirl flow in the volume between the vane discharge edges and the flow diverter. The high swirl often induces the coarse particles to make more than one rotation before reaching the bottom surface of the flow diverter. The vane configuration reinforces the high swirl inducing turbulence that has a tendency to remix the coarse and fine particles within the fluid flow. The relative high velocities and swirl of the fluid flow increases the drag forces within the conventional classifier, resulting in a wide range of coarse particles that exit the classifier with the fluid flow.

The drag coefficient for a particle is proportional to the fluid flow Reynolds Number, a dimensionless property that is in turn proportional to the fluid velocity. The drag force is proportional to the drag coefficient multiplied by the fluid velocity squared. Therefore, if all other flow properties remain the same (i.e., are held constant), then changes in the drag force are proportional to the fluid flow velocity to the third power. The relative high velocities of the conventional classifiers create relative high drag forces that makes selective classification (i.e., classification based on the particle size or ranges of sizes) difficult. The result is a significant portion of both the coarse and fine particles end up in the reclaimed solids that are rejected back to the pulverizing device.

The exemplary classifiers (or new classifiers), as disclosed herein, take advantage of the inertias of the particles to segregate the different particle sizes that enter the classifier in the fluid flow. The new classifiers may include a flow diverter having a profile (or contour) with a vertical radius, wherein the top portion of the housing may intersect the flow diverter along a surface that is tangent to this profile. This configuration influences the trajectories of the particles, such that the coarse particles form a concentrated flow that is close to the peripheral wall of the flow diverter. The concentrated flow of the segregated coarse particles pass along the top surfaces of the blades near the edge of the blades that abuts the flow diverter, while the bulk fluid flow that includes the fine particles tends to be biased toward the bottom surfaces of the blades. The redirection of the fluid flow from substantially horizontal (when entering the vane assembly) to substantially downward (when exiting the vane assembly) helps maintains the segregation of the coarse particles from the bulk fluid flow. The contour of the lower portion (e.g., exit portion) of the flow diverter may direct the concentrated flow of coarse particles away from the bulk fluid flow and toward the inside surface of the cone member that induces capture of the coarse particles below the deflecting members. The fine particles remain in the bulk fluid flow as the flow passes below the flow diverter then turns upwardly toward the outlet of the classifier. With the relatively small swirl component of the velocity, this upward turn may be achieved by the particles while producing less than one revolution around the classifier.

The new classifiers induce relatively low velocities (compared to the conventional classifiers) of the fluid flow that create relatively lower drag forces that are not sufficient to re-entrain the coarse particles back into the bulk fluid flow, which results in an increase classification of coarse particles that are rejected back to be resized and a corresponding increase in fine particles that exit the classifier to the downstream process. In addition, the new classifiers have a relative reduced swirl (compared to the conventional classifiers), which prohibits the higher centrifugal forces that cause fine particles to be rejected back to the pulverizing assembly. The new classifiers cause continuous particle classification throughout the classifier.

TABLE 1
Amount of Inlet Mass Flow based on particle Size (or size
range) used in CFD Analysis (based upon field measurements)

| | Particle Size Range | | | | |
|---|---|---|---|---|---|
| | >300 | 150 | 75 | <75 | |
| | μm | μm-300 μm | μm-150 μm | μm | Total |
| Inlet Mass | 2.740 | 3.654 | 3.654 | 8.221 | 18.270 |
| Flow (kg/s) | | | | | |

TABLE 2
CFD Computer Analysis Results for the Conventional Classifier
Conventional (baseline) Classifier

| | | | | |
|---|---|---|---|---|
| Percent (%) by mass | 28.5% | | | |
| to Reclaim | | | | |
| Particle Size Range | >300 | 150 | 75 | <75 |
| | μm | μm-300 μm | μm-150 μm | μm |

Exiting the Outlet Pipe

| | | | | |
|---|---|---|---|---|
| Mass Flow (kg/s) | 0.22 | 2.62 | 2.65 | 7.57 |
| Mass Percent (%) | 1.7 | 20.1 | 20.3 | 58 |

Entering the Reclaim Pipe

| | | | | |
|---|---|---|---|---|
| Reclaim Mass Flow | 2.52 | 1.04 | 1.01 | 0.65 |
| (kg/s) | | | | |
| Percent (%) of size | 91.9 | 28.3 | 27.6 | 7.9 |
| Range Reclaimed | | | | |

TABLE 3
CFD Computer Analysis Results for
the New (or Exemplary) Classifier
New or Exemplary Classifier

| | | | | |
|---|---|---|---|---|
| Percent (%) by mass | 36.6% | | | |
| to Reclaim | | | | |
| Particle Size Range | >300 | 150 | 75 | <75 |
| | μm | μm-300 μm | μm-150 μm | μm |

Exiting the Outlet Pipe

| | | | | |
|---|---|---|---|---|
| Mass Flow (kg/s) | 0.009 | 0.252 | 3.349 | 7.968 |
| Mass Percent (%) | 0.1 | 2.2 | 28.9 | 68.8 |

Entering the Reclaim Pipe

| | | | | |
|---|---|---|---|---|
| Reclaim Mass Flow | 2.731 | 3.402 | 0.305 | 0.253 |
| (kg/s) | | | | |
| Percent (%) of size | 99.7 | 93.1 | 8.3 | 3.1 |
| Range Reclaimed | | | | |

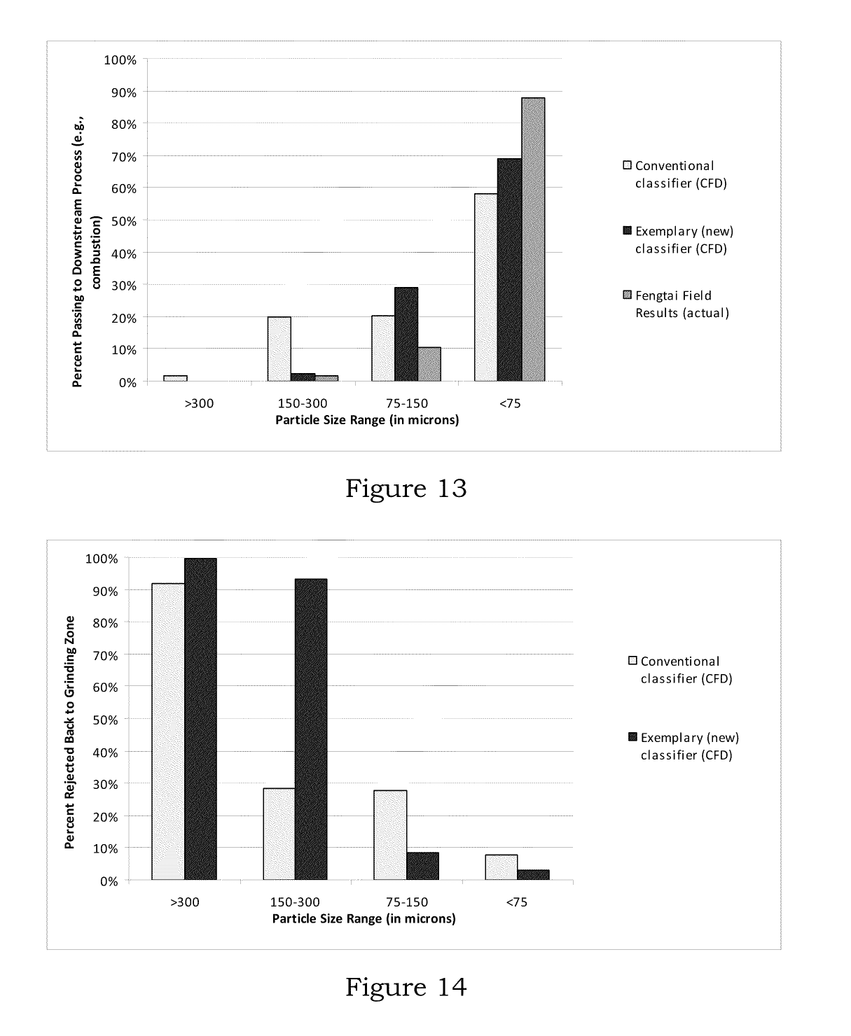

FIGS. 13 and 14 are intended to help illustrate the information provide above in Tables 2 and 3 for the CFD modeling analysis that compares the new (or exemplary) classifier with the conventional classifier. FIG. 13 illustrates the percent by mass of the particles size ranges that are predicted (by the CFD analysis) to pass through (e.g., exit) the classifier, such as to be used in the combustion zone. As shown in FIG. 13, the new or exemplary classifier is predicted by the CFD modeling to pass about one-tenth of one percent (0.1%) by mass of the particles having sizes greater than 300 microns, about two and two-tenths percent (2.2%) by mass of the particles having sizes between 150 and 300 microns, about twenty-eight and nine-tenths percent (28.9%) by mass of the particles having sizes between 75 and 150 microns, and about sixty-eight and eight-tenths percent (68.8%) by mass of the particles having sizes less than 75 microns downstream (i.e., exit the classifier to be used for combustion). For comparison, the conventional classifier is predicted by the CFD modeling to pass about one and seven-tenths percent (1.7%) by mass of the particles having sizes greater than 300 microns, about twenty and one-tenth percent (20.1%) by mass of the particles having sizes between 150 and 300 microns, about twenty and three-tenths percent (20.3%) by mass of the particles having sizes between 75 and 150 microns, and about fifty-eight percent (58%) by mass of the particles having sizes less than 75 microns downstream (i.e., exit the classifier to be used for combustion). Thus, the new classifier (relative to the conventional classifier) allows a greater percent by mass of the fine particles to pass through, while allowing a lower percent by mass of the coarse particles to pass through, which results in an improved efficiency pulverizer classifier system.

As discussed above, the conventional and exemplary classifiers were analyzed using CFD (e.g., computer modeling). However, the third data series in the chart of FIG. 13 illustrates actual data taken from a working field installation that was installed at the 2×600 MWₙₑₜ Fengtai Power Station, located in the Anhui Province of China, as a full-scale experimental demonstration unit to validate the performance of a new (or exemplary) classifier. For comparison, the new working-test sample classifier was measured to pass about zero percent (0%) by mass of the particles having sizes greater than 300 microns, about one and five-tenths percent (1.5%) by mass of the particles having sizes between 150 and 300 microns, about ten and five-tenths percent (10.5%) by mass of the particles having sizes between 75 and 150 microns, and about eighty-seven and nine-tenths percent (87.9%) by mass of the particles having sizes less than 75 microns downstream (i.e., exit the classifier to be used for combustion). Thus, the actual new classifier performed better than predicted by the CFD modeling.

FIG. 14 illustrates the percent of the particles in each specific size range that are predicted (by the CFD analysis) to be separated (e.g., rejected back to the grinding zone) from the fluid flow by the classifier, such as to be reground for further size reduction by the pulverizing assembly. As shown in FIG. 14, the new or exemplary classifier is predicted by the CFD modeling to reject about ninety-nine and seven-tenths percent (99.7%) of the particles having sizes greater than 300 microns, about ninety-three and one-tenth percent (93.1%) of the particles having sizes between 150 and 300 microns, about eight and three-tenths percent (8.3%) of the particles having sizes between 75 and 150 microns, and about three and one-tenth percent (3.1%) of the particles having sizes less than 75 microns. For comparison, the conventional classifier is predicted by the CFD modeling to reject about ninety-one and nine-tenths percent (91.9%) of the particles having sizes greater than 300 microns, about twenty-eight and three-tenths percent (28.3%) of the particles having sizes between 150 and 300 microns, about twenty-seven and six-tenth percent (27.6%) of the particles having sizes between 75 and 150 microns, and about seven and nine-tenths percent (7.9%) of the particles having sizes less than 75 microns. Thus, the new classifier (relative to the conventional classifier) rejects a lower percent by mass of the fine particles back to be resized, while rejecting a higher percent by mass of the coarse particles to be resized, which results in an improved efficiency pulverizer classifier system. Due to the limitations of the equipment it was unfeasible to measure the percent by mass that was actually rejected back to the grinding zone by the full-scale experimental demonstration (i.e., the working field installation) unit.

Although the pulverizer classifier systems described herein have been shown and described as being used with respect to one particular type of mill, those reviewing this disclosure should recognize that other types of commercially available mills (e.g., vertical spindle mills, horizontal ball tube mills, etc.) or other mill/pulverizer type systems may be modified to incorporate features (e.g., classifier assembly) of the pulverizer classifier systems that are described herein, and that such modifications are intended to be included within the scope of the present disclosure. Such vertical spindle mills may include, for example: HP, RB, RPS, RS, and RP pulverizers that are commercially available from Alstom Power, Inc. (formerly Combustion Engineering, Inc.) of Windsor, Conn.; E, EL, and B&W Roll Wheel pulverizers commercially available from The Babcock and Wilcox Company of Barberton, Ohio; MB, MBF, and ball tube pulverizers commercially available from Foster Wheeler North America Corp. of Clinton, N.J.; MPS and ball tube pulverizers commercially available from Riley Power of Worcester, Mass., and any other pulverizer that may be available.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the classifiers as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An axial classifier for separating coarse particles from a fluid flow having both coarse and fine particles, comprising:
a housing forming a first chamber for the fluid flow to enter the classifier;
a vane assembly provided within the housing, wherein the vane assembly includes a plurality of blades aligned around a flow diverter;
a cone member forming a second chamber for the fluid flow to pass therein, wherein the cone member includes an opening for the coarse particles separated from the fluid flow to pass therethrough; and
an outlet for the particles remaining in the fluid flow after separation of the coarse particles to exit the classifier;
wherein the plurality of blades of the vane assembly abut a surface of the flow diverter to direct the fluid flow from the first chamber into the second chamber in a manner that congregates the coarse particles for classification.

2. The axial classifier of claim 1, wherein the plurality of blades of the vane assembly are aligned having a pitch angle to control the swirl and velocity of the fluid flow passing from the first chamber to the second chamber.

3. The axial classifier of claim 1, wherein the outer surface of the flow diverter that abuts the blades of the vane assembly is concave.

4. The axial classifier of claim 1, further comprising a deflecting member aligned at an angle of taper to direct the fluid flow having fine particles away from the opening of the cone member, wherein a gap exists between the deflecting member and the cone member to permit the coarse particles to pass therethrough to isolate the coarse particles from the fluid flow.

5. The axial classifier of claim 4, further comprising a second deflecting member aligned at a second angle of taper to additionally direct the fluid flow having fine particles away from the opening of the cone member and to isolate additional coarse particles from the fluid flow.

6. The axial classifier of claim 1, wherein the housing receives the fluid flow from a pulverizing assembly that operates to reduce the size of the particles contained in the fluid flow.

7. The axial classifier of claim 6, further comprising an inlet pipe that introduces particles contained in the fluid flow into the pulverizing assembly.

8. The axial classifier of claim 1, wherein the particles are of a solid fuel.

9. The axial classifier of claim 1, wherein the plurality of blades are aligned in a radial direction around the flow diverter.

10. The axial classifier of claim 9, wherein the plurality of blades aligned in the radial direction produce an axial clockwise rotation of the fluid flow around the flow diverter.

11. The axial classifier of claim 9, wherein the plurality of blades aligned in the radial direction produce an axial counter-clockwise rotation of the fluid flow around the flow diverter.

12. The axial classifier of claim 1, wherein each blade of the plurality of blades includes a curved portion along the lower edge of the blade to direct the fluid flow exiting the vane assembly.

13. A pulverizer classifier system, comprising:
an inlet pipe having a first end and a second end, wherein the first end receives particles of a raw material and the second end outputs the particles of the raw material;
a pulverizing assembly that is configured to receive the particles of the raw material from the inlet pipe, wherein the pulverizing assembly is configured to reduce the size of the particles and to output the fluid flow comprising coarse and fine particles of the raw material; and
an axial classifier that is configured to receive the fluid flow from the pulverizing assembly and separates the coarse particles of the raw material from the fluid flow based on at least one of the size or weight of the coarse particles, wherein the axial classifier includes a housing forming a first chamber, a cone member forming a second chamber, a vane assembly, and a flow diverter;
wherein the vane assembly includes a plurality of blades that are aligned around the flow diverter having a pitch angle to control the swirl and velocity of the particles of the fluid flow passing from the first chamber to the second chamber;
wherein the cone member includes an opening for the coarse particles separated from the fluid flow to pass through to reenter the pulverizing assembly.

14. The pulverizer classifier system of claim 13, wherein the plurality of blades of the vane assembly abut an outer surface of the flow diverter to direct the fluid flow from the first chamber into the second chamber in a manner that congregates the coarse particles for classification.

15. The pulverizer classifier system of claim 13, wherein the outer surface of the flow diverter that abuts the blades of the vane assembly is concave.

16. The pulverizer classifier system of claim 13, wherein the axial classifier further includes a deflecting member aligned at an angle of taper to direct the fluid flow having fine particles away from the opening of the cone member.

17. The pulverizer classifier system of claim 16, wherein a gap exists between the deflecting member and the cone member, wherein the coarse particles pass through the gap to exit the classifier and to reenter the pulverizing assembly.

18. The pulverizer classifier system of claim 16, wherein the axial classifier further includes a second deflecting member aligned at a second angle of taper to direct additional fine particles of the fluid flow away from the opening of the cone member.

19. The pulverizer classifier system of claim 13, wherein each blade of the plurality of blades includes a curved portion along the lower edge of the blade to direct the fluid flow exiting the vane assembly.

20. The pulverizer classifier system of claim 13, wherein the plurality of blades are aligned in a radial direction around the flow diverter to produce an axial clockwise rotation of the fluid flow.

21. The pulverizer classifier system of claim 13, wherein the plurality of blades are aligned in a radial direction around the flow diverter to produce an axial counter-clockwise rotation of the fluid flow.

22. The pulverizer classifier system of claim 13, wherein the raw material is coal.
